(19) United States
(12) Patent Application Publication
(10) Pub. No.: US 2006/0030025 A1
(43) Pub. Date: Feb. 9, 2006

(54) Bioremediation of explosives

(76) Inventor: Robert S. Riggs, Granbury, TX (US)

Correspondence Address: CARSTENS & CAHOON, LLP, P O BOX 802334, DALLAS, TX, 75380, US

(21) Appl. No.: 11/080,206

(22) Filed: Mar. 15, 2005

Related U.S. Application Data
(60) Provisional application No. 60/553,665, filed on Mar. 16, 2004.

(51) Int. Cl. B09C 1/10; F42B 5/02

(52) U.S. Cl. 435/262.5; 102/430

(57) ABSTRACT

The present invention provides an explosive charge that includes a casing containing explosive material, a cap coupled to the casing, and fungal spores that, when activated, metabolize and degrade the explosive material. The fungal spores may be located in the ullage of the casing, contained in a biodegradable cap, or encapsulated in biodegradable pellets that are mixed into the explosive material. A wicking strip and/or deliquescent salts may be used to draw moisture into the charge in order to activate the fungal spores, and supporting nutrients may be added to help support fungal metabolism. In one embodiment, the casing also has a biodegradable plug that allows moisture into the casing to support fungal growth. The casing itself may also be biodegradable.

### CROSS-REFERENCE TO RELATED APPLICATION

This application claims the benefit of and priority to a U.S. Provisional Patent Application No. 60/553,665 filed Mar. 16, 2004 the technical disclosure of which is hereby incorporated herein by reference.

### TECHNICAL FIELD

The present invention relates to the degradation of unused explosives to a condition that renders them safe. More specifically, the present invention relates to the use of microorganisms to degrade the explosives.

### BACKGROUND OF THE INVENTION

Explosives are routinely used in the production of gas and oil, as well as for seismic surveys for other geological applications. For example, explosives may be lowered into wells and used to fracture rock in order to facilitation oil and gas extraction. For seismic surveys, the explosives are placed in specific formations around a predefined area, and the vibrations produced by their detonation are used to create image maps of the underlying geological structures. However, a danger is created if the detonator fails to detonate or is lost in the well site or drill hole.

Several methods exist in the prior art for degrading non-detonated explosives. Many of these methods use chemical compounds to degrade the explosives. However, the use of degrading chemicals produces potential environmental problems. To avoid these potential problems, an alternative approach employs microorganisms to metabolize and degrade explosive compounds.

Bioremediation is the application of biological treatment to the cleanup of hazardous chemicals in the soil and surface or subsurface waters. Undergoing complex chemical reactions, the waste is metabolized into the final metabolic waste products, water and carbon dioxide. This process provides the bacteria with the energy they need to live. The end result of this natural process is that wastes are used up or converted into a less harmful form. necessary for the proper functioning of the bacteria. The enzymes break up long, complex waste molecules into smaller ones that can be digested directly by the bacteria. Essential nutrients can be added to supply the vitamins and minerals required for the growth and activity of the bacteria. These vitamins and minerals might not be present at the contamination site, and a lack of any one of them will inhibit the growth or reproduction of the microbes.

Methods of bioremediation include bioaugmentation in which microbes and nutrients are added to the contaminated site. Bacteria and nutrients are spread over or injected directly into the contaminated site, and nutrients and enzymes that stimulate the activity of the bacteria are added.

Many prior art approaches address explosives as dispersed environmental pollutants or as collected stockpiles. However, this approach is not particularly useful in dealing with intact explosive charges that remain undetonated, e.g., due to a detonation fault. A few designs have attempted to incorporate bacterial cultures into the explosive charges themselves, providing a built-in mechanism for degrading the explosive material in the case of a detonation failure. However, bacterial physiology does not make bacteria the best candidates for long-term incorporation into explosive charge designs.

Fungi provide a more viable alternative to bacteria for incorporation into explosive charge designs. Fungi are a group of organisms ranked as a kingdon within the Domain Eukaryota. Fungi have a vegetative body called a thallus or soma composed of filaments called hyphae. These generally form a microscopic network within a nutritive substrate called the mycelium, through which food is absorbed. The division of hyphae into cells is either incomplete or absent. However, unlike bacteria, the hyphae may be modified to produce highly specialized cellular-scale structures.

Fungi are heterotrophic, obtaining their energy by breaking down organic molecules. Similar to bacteria, fungi feed by secreting exoenzymes into the surrounding substrate to break apart large organic molecules. The resulting smaller organic molecules are then absorbed by the fungal cells. In general, fungi can attack and break down a greater range of substances than bacteria.

Fungi may reproduce sexually and asexually. Usually the most conspicuous parts of a fungus are fruiting bodies, reproductive structures that produce spores. Spores are substrate to break apart large organic molecules. The resulting smaller organic molecules are then absorbed by the fungal cells. In general, fungi can attack and break down a greater range of substances than bacteria.

Fungi may reproduce sexually and asexually. Usually the most conspicuous parts of a fungus are fruiting bodies, reproductive structures that produce spores. Spores are unicellular reproductive or resistant bodies that are adapted to survive unfavorable environmental conditions and to produce new fungi when conditions improve. Spores accomplish their function by dehydration, which keeps them in a metabolically inactive, reversible rest state. Activation of dormant spores requires water and a physical or chemical activator. If a spore has been activated but dries up, the spore will remain activated, and as soon as the proper environmental conditions arise, the spore will germinate. This resilient characteristic enables spores to survive adverse environmental conditions for extended periods of time, making spore-forming fungi better candidates than bacteria for incorporation into explosive charges.

Therefore, it would be desirable to have a way to degrade non-detonated, intact explosive charges, wherein the degradation occurs via fungi or fungal spores incorporated into the charges themselves, allowing for controlled, predictable degradation should detonation fail.

### SUMMARY OF THE INVENTION

The present invention provides an explosive charge that includes a casing containing explosive material, a cap coupled to the casing, and fungal spores that, when activated, metabolize and degrade the explosive material. The fungal spores may be located in the ullage of the casing, contained in a biodegradable cap, or encapsulated in biodegradable pellets that are mixed into the explosive material. A wicking strip and/or deliquescent salts may be used to draw moisture into the charge in order to activate the fungal spores, and supporting nutrients may be added to help support fungal metabolism. In one embodiment, the casing also has a biodegradable plug that allows moisture into the casing to support fungal growth. The casing itself may also be biodegradable.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 shows an exploded view of a seismic charge in accordance with the present invention;

FIG. 2 depicts an explosive charge incorporating fungal spores into the charge cap in accordance with the present invention;

FIG. 3 depicts an alternate embodiment of the explosive device incorporating fungal spores into the ullage of the casing; and

FIG. 4 shows an alternate embodiment in which the fungal spores are mixed directly into the explosive material.

### DETAILED DESCRIPTION OF THE DRAWINGS

The present invention incorporates fungi (preferably fungal spores) into seismic explosive devices, allowing predictable degradation of the explosive material in case the device fails to properly detonate. The invention thus eliminates the need to locate and remove non-detonated devices by allowing them to degrade on their own.

Fungi comprise a kingdom of eucaryotic, absorptive heterotrophs containing filamentous hyphae. Fungi may reproduce both sexually and asexually, but reproduction almost always involves the production of spores.

Fungi normally live embedded in a “food” substrate and may release enzymes which break down almost any carbon based substrate into smaller molecules that the fungi may absorb and further metabolize it. For example, the back mold, Stachybotrys, may decompose asphalt, and the white rot fungus, Bjerkandera sp BOS55, degrades chlorinated aromatics, such as PCP, and polycyclic aromatic compounds, such as benzopyrene.

Such fungi or their spores may be blended into an explosive material or placed in close proximity to the explosive in a variety of ways so as to result in the eventual decomposition of the explosive material. The fungi may be placed in a secondary metabolic state to facilitate metabolism of the explosives, such as disclosed in U.S. Pat. No. 5,085,998.

Examples of fungi that are suitable for use in the present invention include:
Ascomycete mycelia
Bjerkandera sordidicola sp BOS55
Phlebia radiata
Pycnoporus cinnabarinus
Stachybotrys
Inonotius dryophilus
Perenniporia medulla-panis
Ganoderma oregonense
Trametes versicolor
Phellinus badius
Agaricus bisporus
Pieurotus ostreatus
Lentinula edodes
Phanerochaete Chrysosporium

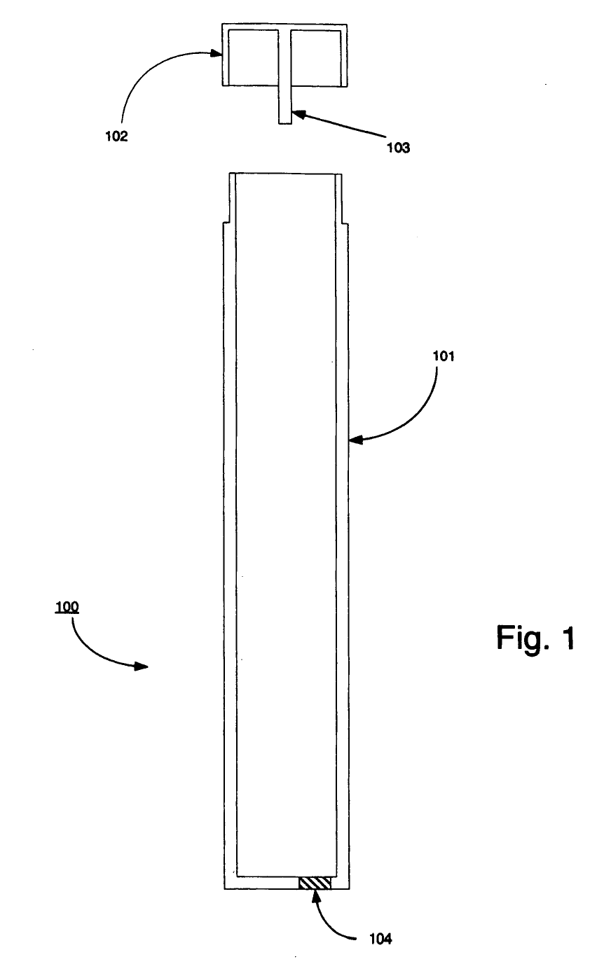

FIG. 1 shows an exploded view of a seismic charge in accordance with the present invention. The charge 100 is comprised of two principal parts: the casing 101 that contains the actual explosive material and the cape 102 containing a cap well 103 through which a detonator is inserted. The casing 101 may contain a biodegradable plug 104 that allows moisture into the casing to facilitate the growth of fungus (explained in more detail below). In addition, the both the casing 101 and cap 102 may be biodegradable.

Biodegradable material may comprise conventional biodegradable plastics or naturally occurring polymers such as cellulose or chitin, as well as various glues or adhesives or energetic compositions such as water gels or reverse emulsions. Examples of biodegradable plastics include polyglycolic acid, polylactic acid, polycaprolactone, polyhydroxybutyrate, polyhydroxyvalerate, polyvinyl alcohol, polyvinyl acetate, and polyenlketone.

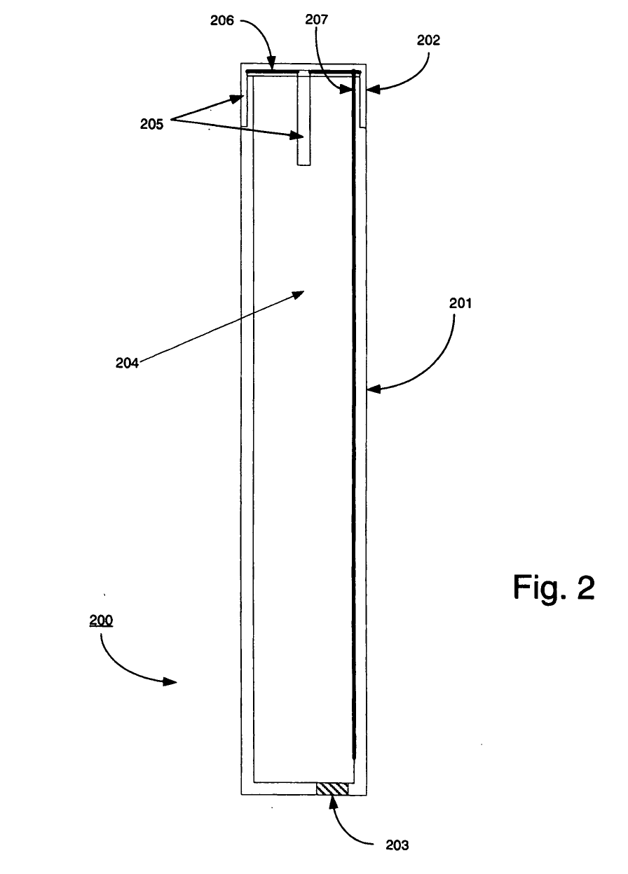

FIG. 2 depicts an explosive charge incorporating fungal spores into the charge cap in accordance with the present invention. Similar to FIG. 1, the charge 200 comprises a casing 201 that contains the explosive material 204. The charge 200 also has a plastic cap 202 with a biodegradable insulating seal 206 that separates the cap 202 from the explosive material 204. The cap 202 and seal 206 can be made from many of the common biodegradable materials known in the art, such as the ones listed above.

The cap 202 contains fungal spores 205 and the nutrients to support their growth and proliferation, allowing them to metabolize the explosive material 204. The supporting nutrients may include amino acids, carbohydrates, vitamins and electrolytes. A wicking strip 207 draws water into the casing 201 by capillary action. Deliquescent salts (e.g., ammonium nitrate) may also be used to draw moisture from the air and liquefy the fungal growth medium.

After the explosive charge 200 is placed into the ground, if for some reason, the device does not detonate it may simply be left in place. The wicking strip 207 and deliquescent salts will draw moisture into the casing 201 and allow the fungal spores 205 to grow and proliferate in the supplied nutritional medium. As the fungi become metabolically active, they degrade and metabolize the insulating seal 206 and cap 202 that separate the spores from the explosive material 204, allowing the fungi to come into contact with the explosive material 204 and begin metabolizing and degrading it. Since the explosive material 204 becomes a food source for the fungi, the degradation process is self-sustaining until the explosive material is completely metabolized.

A biodegradable plug 203 may also be placed in the bottom of the charge casing 201 to allow moisture into the explosive material 204, further supporting proliferation of the fungi. As explained above, the casing itself 201 may also be biodegradable, thus minimizing the amount of man made materials remaining in the ground.

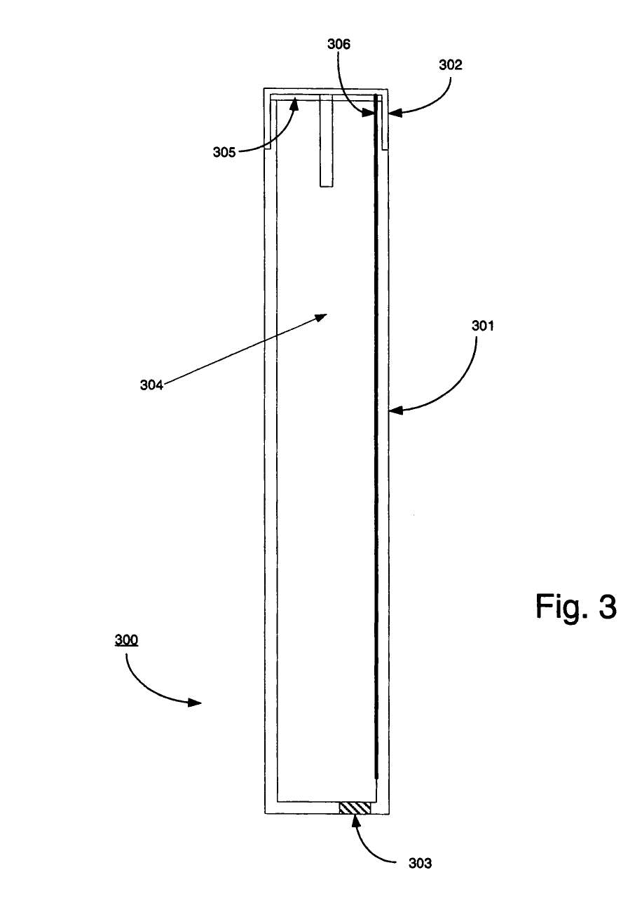

FIG. 3 depicts an alternate embodiment of the explosive device incorporating fungal spores into the ullage of the casing. In this embodiment, rather than storing the fungal spores and supporting nutrients in the plastic cap 302, they are stored in the ullage 305 at the top of the charge casing 301, placing them in direct contact with the explosive material 304.

As with the charge in FIG. 2, a wicking strip 306 again extends down the inside of the plastic casing 301 to allow moisture to be drawn directly into the explosive material 304. Water may also be allowed into the casing 301 by way of a biodegradable plug 303 in the bottom.

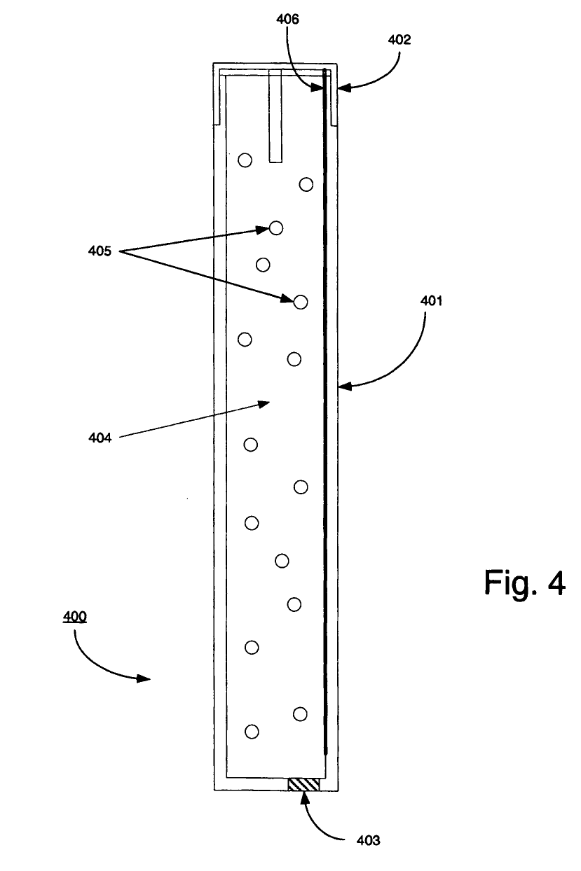

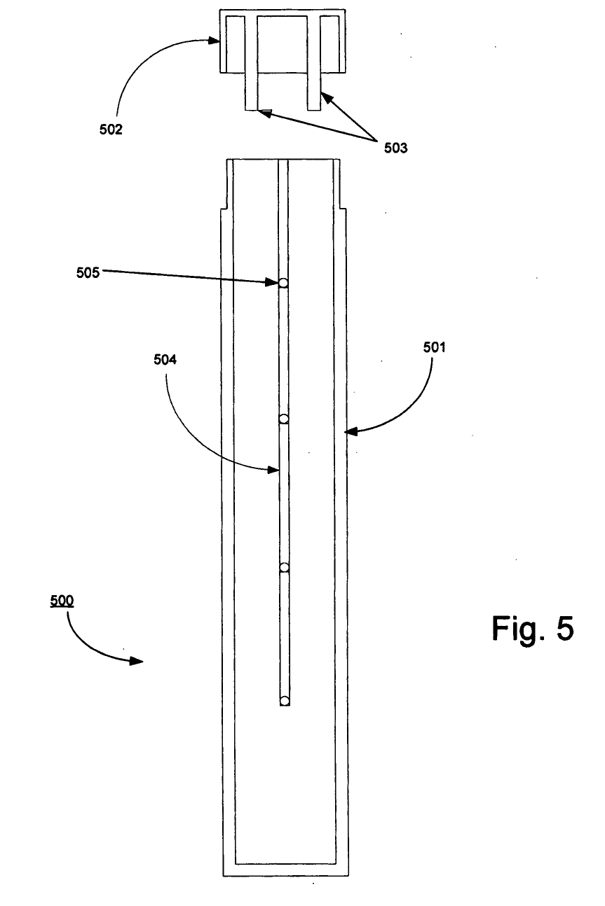

FIG. 4 shows an alternate embodiment in which the fungal spores are mixed directly into the explosive material. In this embodiment, rather than storing the fungal spores and supporting nutrients in the plastic cap 402 or simply placing them in the ullage, the spores and nutrients are encapsulated in biodegradable pellets 405 which are then mixed into the explosive material 404. The pellets 405 can be made from any of the common biodegradable materials listed above, as well as any other biodegradable material known in the art.

As with the other embodiments, a wicking strip 406 extends down the inside of the plastic casing 401, and a biodegradable plug 403 is placed in the bottom of the casing 401 to allow moisture to be drawn directly into the explosive material 404. Again, the casing 401 may also be biodegradable.

The speed with which the explosive material is degraded can be adjusted according to the specific biodegradable material used for the pellets and the number of pellets mixed into the explosive material (e.g. 10, 20, etc.). Obviously, the faster the pellets degrade and release the fungus, and the more pellets there are, the faster the explosive material will be completely metabolized. This approach provides the manufacturer with flexibility in manipulating shelf life and safety (in the ground) of the explosive charge. For example, a charge with 5 pellets may degrade very slowly and have a relatively long shelf life, making it suitable for use in remote areas with relatively little human traffic, whereas a charge with 30 pellets will have a much shorted shelf life, but will be safer to leave in the ground in areas with higher traffic or expected higher traffic in the near future (e.g. construction sites).

FIG. 5 shows yet another embodiment of the present invention comprising a self contained microbial growth medium. This embodiment is similar to the one depicted in FIG. 4 in that the fungal spore capsules 505 are incorporated directly into the casing 501 containing the high explosive material, rather than the cap 502. However, in this embodiment, the fungal spore capsules 505 are contained in a series of stack nutrient emulsion tubes 504.

The nutrient emulsion tubes 504 provide a completely self contained growth medium for the fungal spores that does not require extrinsic moisture to be drawn into the charge casing. In addition to supporting nutrients, the emulsion tubes 504, as the name implies, also contain a water/oil emulsion that provides the necessary moisture to support fungal growth. The tubes themselves are biodegradable to allow the fungus to come into contact with the explosive material and can be made from paper, gelatin or any of the other biodegradable materials described above.

By providing moisture through the emulsion, this embodiment eliminates the need for a wicking strip or biodegradable external plug to draw moisture into the casing 501. However, these features can certainly be added, depending on the needs of the user and the environment in which the charge will be deployed.

The self contained emulsion growth medium is particularly well suited for use in environments that contain little moisture or have little rainfall, making the degradation of the explosive material more reliable and predictable.

It should also be pointed out that the cap 502 depicted in FIG. 5 has two cap wells 503. Two wells are used for redundancy in detonator leads to increase the reliability of a successful detonation. This double well design can also be applied to any of the other embodiments described above.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

We claim:

1. An explosive charge, comprising:
(a) a casing containing explosive material;
(b) a cap coupled to said casing; and
(c) fungal spores that, when activated, metabolize and degrade the explosive material.

2. The explosive charge according to claim 1, wherein the fungal spores are stored in an ullage in the casing.

3. The explosive charge according to claim 1, wherein the fungal spores are encapsulated in biodegradable pellets that are mixed into the explosive material.

4. The explosive charge according to claim 3, wherein the biodegradable pellets are made from at least one of the following materials:
polyglycolic acid;
polylactic acid;
polycaprolactone;
polyhydroxybutyrate;
polyhydroxyvalerate;
polyvinyl alcohol;
polyvinyl acetate;
and polyenlketone.

5. The explosive charge according to claim 1, wherein the fungal spores are contained in said cap, wherein the cap is biodegradable, and wherein the spores become active and move into the casing as the cap biodegrades.

6. The explosive charge according to claim 5, wherein the cap is made from at least one of the following materials:
polyglycolic acid;
polylactic acid;
polycaprolactone;
polyhydroxybutyrate;
polyhydroxyvalerate;
polyvinyl alcohol;
polyvinyl acetate;
and polyenlketone.

7. The explosive charge according to claim 1, wherein the casing is biodegradable.

8. The explosive charge according to claim 7, wherein the casing is made from at least one of the following materials:
polyglycolic acid;
polylactic acid;
polycaprolactone;
polyhydroxybutyrate;
polyhydroxyvalerate;
polyvinyl alcohol;
polyvinyl acetate;
and polyenlketone.

9. The explosive charge according to claim 1, further comprising a wicking strip for drawing moisture into the casing.

10. The explosive charge according to claim 1, further comprising deliquescent salts for drawing moisture into the casing.

11. The explosive charge according to claim 1, further comprising a biodegradable plug in the casing for allowing moisture into the casing.

12. The explosive charge according to claim 1, further comprising nutrients to support fungal metabolism.

13. The explosive charge according to claim 12, wherein the supporting nutrients may include amino acids, carbohydrates, vitamins and electrolytes.

14. The explosive charge according to claim 1, wherein the fungal spores may be from at least one of the following species of fungi:
Ascomycete mycelia;
Bjerkandera sordidicola sp BOS55;
Phlebia radiate;
Pycnoporus cinnabarinus;
Stachybotrys;
Inonotius dryophilus;
Perenniporia medulla-panis;
Ganoderma oregonense;
Trametes versicolor;
Phellinus badius;
Agaricus bisporus;
Pieurotus ostreatus;
Lentinula edodes; and
Phanerochaete Chrysosporium.

15. The explosive charge according to claim 1, wherein the fungal spores are contained in biodegradable tubes inserted into the casing, wherein the tubes provide a self contained growth medium that includes all the supporting nutrients and moisture necessary to support fungal growth.

16. The explosive charge according to claim 15, wherein the moisture in said tubes is supplied by an oil/water emulsion.
